(19) United States
(12) Patent Application Publication
(10) Pub. No.: US 2014/0160468 A1
(43) Pub. Date: Jun. 12, 2014

(54) Optical Waveguide Element Evaluation Apparatus and Optical Waveguide Element Evaluation Method

(71) Applicant: Hitachi, Ltd., Tokyo (JP)

(72) Inventors: Yasuhiko IWANABE, Tokyo (JP); Harukazu MIYAMOTO, Tokyo (JP)

(73) Assignee: Hitachi, Ltd., Tokyo (JP)

(21) Appl. No.: 14/102,853

(22) Filed: Dec. 11, 2013

(30) Foreign Application Priority Data
Dec. 12, 2012 (JP) 2012-271474

(51) Int. Cl. G01M 11/00

(52) U.S. Cl. CPC G01M 11/338
USPC 356/73.1

(57) ABSTRACT

The present invention provides an optical waveguide element evaluation apparatus in which stray light is separated and the distribution of light angles of an optical waveguide element can be evaluated. An optical waveguide element evaluation apparatus includes optical path setting devices that image a near-field pattern at an end face of emission light from an optical waveguide element in the air; a pinhole plate that includes opening portions which the imaged near-field pattern penetrates; and a detection unit that detects the spread angle of the light at the end face of the emission light using a far-field pattern formed of the light penetrating the pinhole plate.

### CLAIM OF PRIORITY

The present application claims priority from Japanese patent application JP 2012-271474 filed on Dec. 12, 2012 the content of which is hereby incorporated by reference into this application.

### BACKGROUND OF THE INVENTION

1. Field of the Invention

The present invention relates to an optical waveguide element evaluation apparatus and an optical waveguide element evaluation method using separation of stray light and analysis of a far field.

2. Description of the Related Art

In order to reduce the number of components, a technique of forming optical elements on a silicon substrate has been studied in recent years in the field of optical integrated circuits and elements (Kevin K. Lee, 5 others “Effect of size and roughness on light transmission in a Si/SiO2 waveguide: Experiments and model” Applied Physics Letters, Volume 77, Number 11, Page 1617-1619). As an optical waveguide through which optical signals are transmitted between optical devices, a PLC (Planar Lightwave Circuit) that produces optical waveguides and various optical devices on an oxide film deposited on a silicon substrate has been already developed, and the optical waveguide on the PLC serves as a core of the optical waveguide by doping a trace of impurities (Ge) into an oxide film as similar to an optical fiber. However, a refractive index difference between the core and the clad (oxide film) is small, and the minimum bend radius of the optical waveguide is in a few mm order (relative refractive index difference Δ=((n₁²−n₂²)/2n₁²=about 0.01, wherein n₁ represents a core refractive index and n₂ represents a clad refractive index). Thus, it is too large in size to be incorporated into a silicon LSI circuit. Accordingly, in order to downsize the optical integrated circuits and elements, plural methods have been studied so that light is confined in a micro region for wave guiding while the minimum bend radius is reduced by increasing the refractive index difference between the core of the optical waveguide and the clad. An element to confine light in a micro region for wave guiding as described above has been studied so as to be adopted to a silicon photonic device as a device studied using a silicon substrate as a base, and a thermal assist magnetic write head in order to form a micro optical spot even in the field in which the Si substrate is not based.

Accordingly, the followings are commonly-used methods to evaluate optical characteristics of a general optical waveguide with a relatively small refractive index difference between the core and the clad: a method (hereinafter, referred to as a butt coupling method) in which the light use efficiency of an optical waveguide is evaluated by coupling emission light from the optical waveguide to another optical waveguide by means of butt coupling; and a method (hereinafter, referred to an NFP observing method) in which the optical spot size of emission light is evaluated by observing a near-field pattern of the emission light from the optical waveguide.

In addition, Japanese Patent Application Laid-Open No. H9 (1997)-61682 discloses a light source position adjustment apparatus in which the position of a light source is promptly adjusted to match the position of a luminous point and the light radiation direction of the light source to a predetermined reference position and a reference optical axis.

### SUMMARY OF THE INVENTION

In the silicon photonic device, the thermal assist magnetic write head, and the like using the method in which light is confined in a micro region for wave guiding by increasing the refractive index difference between the core of the optical waveguide and the clad, the efficiency of light propagation is deteriorated due to defects of the manufacturing process (Kevin K. Lee, 5 others “Effect of size and roughness on light transmission in a Si/SiO2 waveguide: Experiments and model” Applied Physics Letters, Volume 77, Number 11, Page 1617-1619). Further, in the case where the refractive index difference between the core and the clad is large, the divergent angle of light emitted from the core is largely changed depending on the size and shape of the core. Further, in the case where the optical waveguide is of a single mode and the refractive index difference (Δn=n₁−n₂, wherein n₁ represents a core refractive index and n₂ represents a clad refractive index) between the core and the clad is 0.5 or larger, the spot size of the light emitted from the core is 1 μm or smaller.

Further, as a result of the study by the authors, it has been cleared that light emitted from other than a desired position (core), which is referred to as cladding mode or stray light, is more generated in general in the case of the optical waveguide. This means that it is difficult to evaluate the optical characteristics of the silicon photonic device and the thermal assist magnetic write head in the butt coupling method or the NFP observing method. For example, in the case where the light use efficiency is evaluated by the butt coupling method, there is a high possibility that the light emitted from other than the core is coupled to the optical waveguide on the receiving side in the silicon photonic device and the thermal assist magnetic write head with a large amount of stray light, and it is difficult to accurately calculate the light use efficiency. In addition, in the case where the spot size of emission light is evaluated by the NFP observing method, when the spot size of the light emitted from the core is 1 μm or smaller, the spot size becomes less than the light diffraction limit unless a solid immersion lens having at least two lens apertures used for observation is used. Thus, it is difficult to accurately measure the spot size. In “Effect of size and roughness on light transmission in a Si/SiO2 waveguide: Experiments and model”, a method of obtaining a far-field pattern (hereinafter, referred to as FFP) of light condensed by an objective lens is carried out. If the method is used, the spread angle of light can be obtained, and thus the spot size can be analytically derived. However, in the silicon photonic device and the thermal assist magnetic write head with a large amount of stray light, the stray light is also condensed by the objective lens in the method, and the FFP of only the light emitted from the core cannot be obtained. Thus, it is difficult to analytically derive the spot size. Further, a large amount of stray light is generated due to not only a coupling loss to the optical waveguide, but also light scattering by some defect inside the optical waveguide in some cases.

Accordingly, an object of the present invention is to provide an optical waveguide element evaluation apparatus and an optical waveguide element evaluation method in which stray light is separated and the distribution of light angles of an optical waveguide element can be evaluated.

As an embodiment to achieve the above-described object, the present invention provides an optical waveguide element evaluation apparatus that evaluates emission light from an optical waveguide element, the apparatus including: optical path setting devices that image a near-field pattern at an end face of the emission light from the optical waveguide element in the air; a pinhole plate that includes opening portions which the imaged near-field pattern penetrates; and a detection unit that detects the spread angle of the light at the end face of the emission light using a far-field pattern formed of the light penetrating the pinhole plate.

Further, the present invention provides an optical waveguide element evaluation apparatus that evaluates emission light from an optical waveguide element, the apparatus including: an optical system that images a far-field pattern at an end face of emission light using light that is emitted from the end face of the emission light from the optical waveguide element and penetrates a pinhole plate; and a detection unit that detects the spread angle of the light at the end face of the emission light using the far-field pattern.

Further, the present invention provides an optical waveguide element evaluation method including: a first step of emitting light from an end face of emission light from an optical waveguide element; a second step of adjusting a position so that a near-field pattern at the end face of the emission light is overlapped with a pinhole plate; a third step of imaging a far-field pattern at the end face of the emission light using the near-field pattern arranged at the position overlapped with the pinhole plate; and a fourth step of detecting the spread angle of the light at the end face of the emission light by imaging the far-field pattern again through an optical system.

According to the present invention, it is possible to provide an optical waveguide element evaluation apparatus and an optical waveguide element evaluation method in which stray light is separated and the distribution of light angles of an optical waveguide element can be evaluated.

### BRIEF DESCRIPTION OF THE DRAWINGS

FIG. 1 is an outline overall plan view of an optical waveguide element evaluation apparatus according to a first embodiment of the present invention;

FIG. 2 is a basic conceptual diagram for explaining the measurement principle of a far-field pattern (FFP) in a near-field/far-field simultaneous measurement optical system of the optical waveguide element evaluation apparatus shown in FIG. 1;

FIG. 3 is a side view of main parts in the case where an optical waveguide element is a thermal assist magnetic write head including a thermal assist optical waveguide in the optical waveguide element evaluation apparatus shown in FIG. 1;

FIG. 4 is a perspective view of a pinhole plate and a driving unit in the optical waveguide element evaluation apparatus shown in FIG. 1;

FIGS. 5A and 5B are configuration diagrams for showing an example of the pinhole plate having a pin hole and a slit hole in the optical waveguide element evaluation apparatus shown in FIG. 1, in which FIG. 5A is a top view thereof and FIG. 5B is a side view thereof;

FIG. 6 shows a near-field pattern image of a thermal assist magnetic head measured using the pinhole plate and the near-field/far-field simultaneous measurement optical system in the optical waveguide element evaluation apparatus shown in FIG. 1;

FIGS. 7A and 7B show measurement results of the thermal assist magnetic head using the pinhole plate and the near-field/far-field simultaneous measurement optical system in the optical waveguide element evaluation apparatus shown in FIG. 1, in which FIG. 7A shows an FFP image and FIG. 7B is a graph for showing the dependency of FFP image light intensity on angles;

FIG. 8 shows a simulation result of the FFP of light in the neighborhood of a core emitted from an ABS of the thermal assist magnetic write head shown in FIG. 3;

FIG. 9 shows a near-field pattern image of the thermal assist magnetic head measured without the pinhole plate using the near-field/far-field simultaneous measurement optical system in the optical waveguide element evaluation apparatus shown in FIG. 1;

FIGS. 10A and 10B show measurement results of the thermal assist magnetic head without the pinhole plate using the near-field/far-field simultaneous measurement optical system in the optical waveguide element evaluation apparatus shown in FIG. 1, in which FIG. 10A shows an FFP image and FIG. 10B is a graph for showing the dependency of FFP image light intensity on angles;

FIG. 11 is a graph for showing the dependency of the ratio of stray light intensity/core emission light intensity on the diameter D1 of the pinhole in the case of using the optical waveguide element evaluation apparatus shown in FIG. 1;

FIG. 12 shows FFP images (upper diagrams) and near-field images (lower diagrams) obtained when changing a distance L2 between the ABS of the thermal assist magnetic head and an objective lens using the pinhole plate and the near-field/far-field simultaneous measurement optical system in the optical waveguide element evaluation apparatus shown in FIG. 1;

FIG. 13 is a diagram for showing a moving direction (Y direction) of the pinhole plate with a slit relative to the near-field pattern imaged in the air when an area with the highest stray light intensity in the FFP image is obtained for each emission angle using the optical waveguide element evaluation apparatus shown in FIG. 1;

FIG. 14 is a diagram for showing a moving direction (X direction) of the pinhole plate with a slit relative to the near-field pattern imaged in the air when an area with the highest stray light intensity in the FFP image is obtained for each emission angle using the optical waveguide element evaluation apparatus shown in FIG. 1;

FIG. 15 is a diagram for showing a processing flow used when an area with the highest stray light intensity in the FFP image is obtained for each emission angle using the optical waveguide element evaluation apparatus shown in FIG. 1;

FIG. 16 shows stray light intensity maps of arbitrary angles on an ABS plane obtained using the processing flow of FIG. 15;

FIGS. 17A and 17B are outline views of main parts in the case where the optical waveguide element is another thermal assist magnetic write head including a thermal assist optical waveguide in the optical waveguide element evaluation apparatus shown in FIG. 1, in which FIG. 17A is a top view thereof and FIG. 17B is a side view thereof;

FIG. 18 is an outline overall plan view of an optical waveguide element evaluation apparatus according to a second embodiment of the present invention; and

FIG. 19 is an outline overall plan view of an optical waveguide element evaluation apparatus according to a third embodiment of the present invention.

### DETAILED DESCRIPTION OF THE INVENTION

### First Embodiment

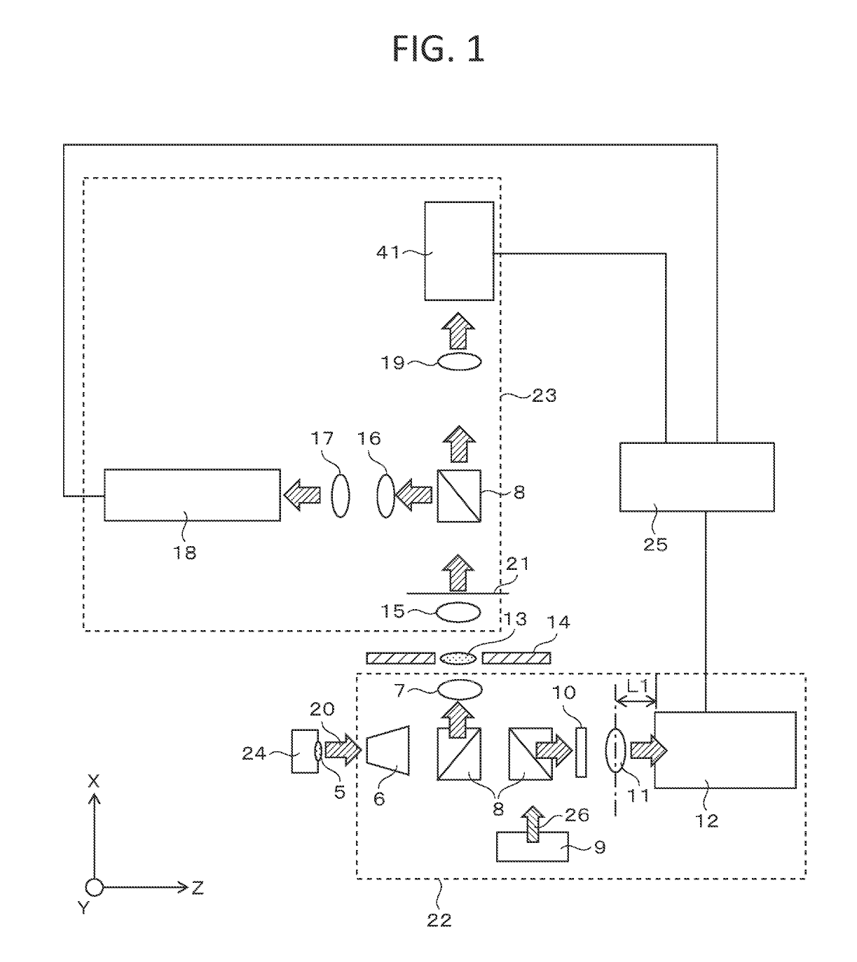

A first embodiment of the present invention will be described using FIG. 1 to FIGS. 17A and 17B. First, the entire configuration of an optical waveguide element evaluation apparatus according to the embodiment will be described using FIG. 1. It should be noted that the same reference numerals denote the same constitutional elements. FIG. 1 is a plan view of the optical waveguide element evaluation apparatus according to the embodiment that makes an evaluation by separation of stray light and a far field analysis. The optical waveguide element evaluation apparatus is configured using an optical waveguide element 24 that is a measurement target, an element emission light imaging optical system 22, a pinhole plate 14 having a pinhole, and a near-field/far-field simultaneous measurement optical system 23. A first near-field pattern observing CCD image sensor 12 provided in the element emission light imaging optical system 22, an FFP observing CCD image sensor 18 provided in the near-field/far-field simultaneous measurement optical system 23, and a second near-field pattern observing CCD image sensor 41 are connected to an image outputting computer 25, and each image obtained by the CCD image sensors 12, 18, and 41 is output by the image outputting computer 25. Further, the surfaces of a second imaging convex lens 7, a first imaging convex lens 11, a half beam splitter 8, and a neutral density filter 10 used in the element emission light imaging optical system 22, and the surfaces of a condensing convex lens 15, a convex lens (1)16, a convex lens (2)17, a third imaging convex lens 19, and a half beam splitter 8 used in the near-field/far-field simultaneous measurement optical system 23 are coated with antireflective films to suppress reflection of light at the end faces. It should be noted that the condensing convex lens or the like is illustrated as a single lens, but plural lenses may be combined with each other to configure a group of lenses.

Next, the element emission light imaging optical system 22 will be described in detail. It should be noted that the element emission light imaging optical system 22 will be described using the Z direction of FIG. 1 as a reference. First, in order to observe an image 5 of an object provided at the front-side focal position of an objective lens 6, the first imaging convex lens 11 is disposed on the rear side of the objective lens 6, and further, the near-field pattern observing CCD image sensor 12 is disposed on the rear side of the first imaging convex lens 11. The reference numeral 20 denotes a travelling direction of emission light of the optical waveguide element. It should be noted that a distance L1 between the first imaging convex lens 11 and the near-field pattern observing CCD image sensor 12 is the same as the focal distance of the first imaging convex lens 11. With this configuration, the image (near-field pattern image) 5 of the object provided at the front-side focal position of the objective lens 6 can be imaged on the near-field pattern observing CCD image sensor 12. It should be noted that the image of the object provided at the front-side focal position of the objective lens 6 is defined as the near-field pattern 5. In this case, if the near-field pattern 5 is dark, an image obtained by the near-field pattern observing CCD image sensor 12 is also dark, and it is difficult to identify the object. Thus, a light source for illumination 9 is installed to input illumination light. The reference numeral 26 denotes a travelling direction of emission light of the light source for illumination. The light emitted from the light source for illumination 9 is turned in the direction of the objective lens 6 by the half beam splitter 8. Accordingly, if a light emission end of the optical waveguide element 24 is disposed at the front-side focal position of the objective lens 6, an image of the emission end face is imaged on the near-field pattern observing CCD image sensor 12. Accordingly, an image output from the near-field pattern observing CCD image sensor 12 to the image outputting computer 25 becomes a light intensity distribution image of the near-field pattern 5 on a plane. It should be noted that in consideration of a case in which the brightness of the image of the near-field pattern observing CCD image sensor 12 output from the image outputting computer 25 is saturated because the image imaged on the near-field pattern observing CCD image sensor 12 is too bright, the neutral density filter 10 can be inserted on the front side of the first imaging convex lens 11 in the embodiment. Further, the near-field pattern 5 can be magnified and imaged even at a position other than the near-field pattern observing CCD image sensor 12. The half beam splitter 8 is installed on the rear side of the objective lens 6, and the half the amount of light propagated on the rear side of the objective lens 6 can be propagated in the X direction of FIG. 1. The second imaging convex lens 7 is installed ahead of the half beam splitter 8 in the X direction. In this case, the focal distance of the second imaging convex lens 7 adopted is longer than that of the objective lens 6. In the embodiment, the objective lens 6 used has a focal distance of 1.8 mm or 3.6 mm, and the second imaging convex lens 7 used has a focal distance of 20 mm or 40 mm. Accordingly, the near-field pattern 5 can be imaged while being magnified about 11 times at the focal position of the second imaging convex lens 7 ahead of the second imaging convex lens 7.

Next, the near-field/far-field simultaneous measurement optical system 23 will be described in detail. The near-field/far-field simultaneous measurement optical system 23 is configured using an optical system that observes an image of a near-field pattern 13 imaged in the air corresponding to the focal position of the second imaging convex lens 7 ahead of the second imaging convex lens 7, and an FFP measurement optical system that measures the light spread angle of the near-field pattern 13 imaged in the air. It should be noted that the near-field/far-field simultaneous measurement optical system 23 will be described using the X direction of FIG. 1 as a reference. In the optical system that observes the image of the near-field pattern 13 imaged in the air, the position of the condensing convex lens 15 is adjusted so that the near-field pattern 13 imaged in the air is located at the front-side focal position of the condensing convex lens 15 to observe the image of the near-field pattern 13 imaged in the air. The third imaging convex lens 19 is disposed on the rear side of the condensing convex lens 15, and the second near-field pattern observing CCD image sensor 41 is disposed on the rear side of the third imaging convex lens 19. It should be noted that a distance between the third imaging convex lens 19 and the second near-field pattern observing CCD image sensor 41 is the same as the focal distance of the third imaging convex lens 19. Accordingly, the image of the near-field pattern 13 imaged in the air that is located at the front-side focal position of the condensing convex lens 15 can be imaged on the second near-field pattern observing CCD image sensor 41. Accordingly, if a light emission end of the optical waveguide element 24 is disposed at the front-side focal position of the objective lens 6, an image of the emission end face is imaged on the second near-field pattern observing CCD image sensor 41. Accordingly, an image output from the second near-field pattern observing CCD image sensor 41 to the image outputting computer 25 becomes a light intensity distribution image of the near-field pattern 5 on a magnified plane.

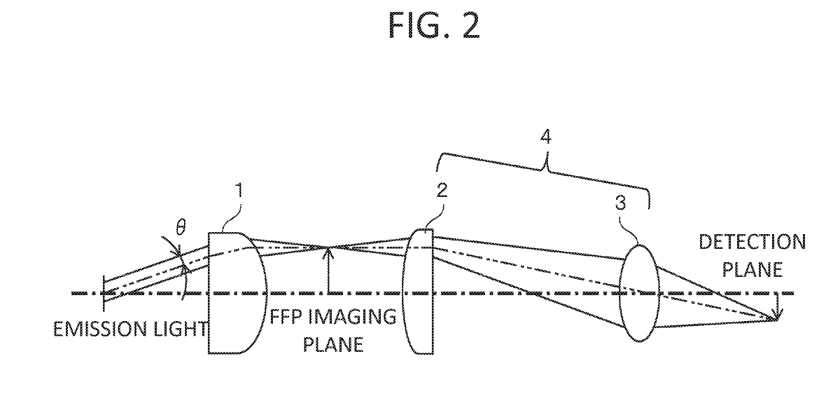

Next, the FFP measurement optical system that measures the light spread angle of the near-field pattern 13 imaged in the air will be described. Here, the basic concept of FFP measurement will be described. FIG. 2 is a diagram for showing the basic concept to measure the FFP using lenses. When emission light from an object is condensed by a first convex lens 1, the FFP of the emission light is imaged on the rear side of the first convex lens 1. If the light is imaged on a detection plane by another lens, the FFP image of the emission light can be obtained. It should be noted that in order to image the FFP on the detection plane, it is necessary to relay the light onto the detection plane using a relay lens 4 composed of a second convex lens 2 and a third convex lens 3. Accordingly, the FFP image of the near-field pattern 13 imaged in the air is imaged on the rear side of the condensing convex lens 15 in the near-field/far-field simultaneous measurement optical system 23 of FIG. 1. In FIG. 1, the image position of the FFP image is referred to as an FFP image position 21. The FFP image imaged at the FFP image position 21 is imaged on the FFP observing CCD image sensor 18 by a relay lens composed of the convex lens (1)16 and the convex lens (2)17 through the half beam splitter 8. Here, the position of the convex lens (1)16 is moved and adjusted in the Z direction so that the focal position of the convex lens (1)16 corresponds to the FFP image position 21. It should be noted that the FFP image of the near-field pattern 13 imaged in the air that is obtained as described above is the same as that obtained from the near-field pattern 5. Because the near-field pattern 13 imaged in the air is different in size, but is the same as the near-field pattern 5 imaged by the element emission light imaging optical system 22. Thus, information of the light spread angle of the near-field pattern 5 is taken over to the near-field pattern 13 imaged in the air.

Next, the pinhole plate 14 will be briefly described. The pinhole plate 14 is used to measure only an arbitrary part of light of the near-field pattern 13 imaged in the air using the near-field/far-field simultaneous measurement optical system 23. The pinhole plate 14 is installed so as to be substantially overlapped with the position of the near-field pattern 13 imaged in the air. Further, a hole with a size corresponding to an area to be observed in the near-field pattern 13 imaged in the air is provided in the pinhole plate 14. If the pinhole plate 14 is moved in the Z direction and the Y direction to move the center of the hole of the pinhole plate to an arbitrary position on the near-field pattern 13 imaged in the air, only light on the near-field pattern 13 imaged in the air that penetrates the hole of the pinhole plate can be measured at the position by the near-field/far-field simultaneous measurement optical system 23.

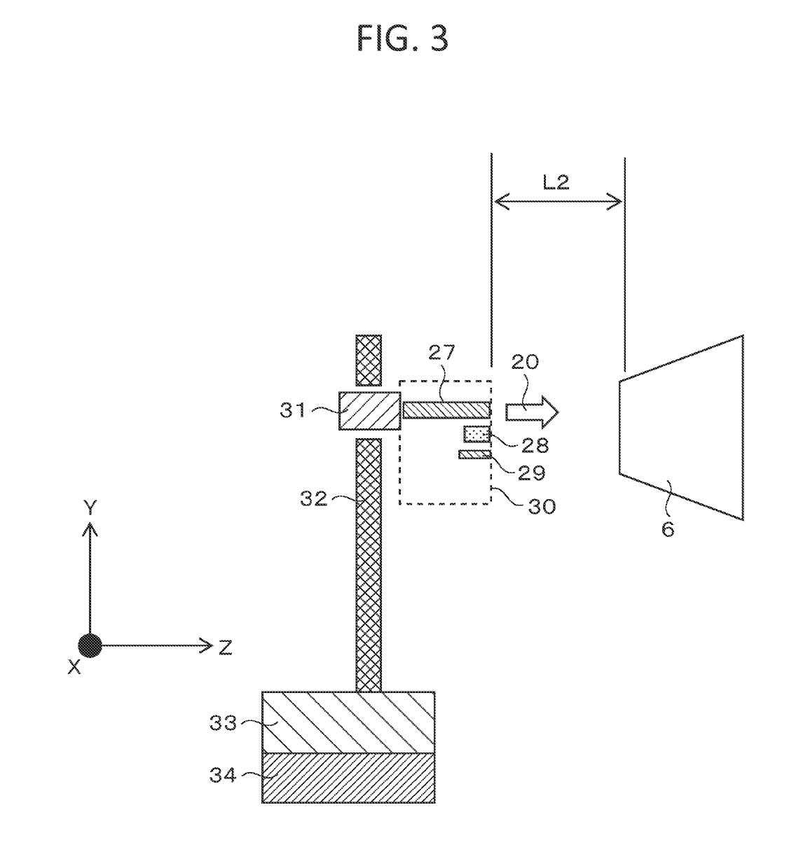

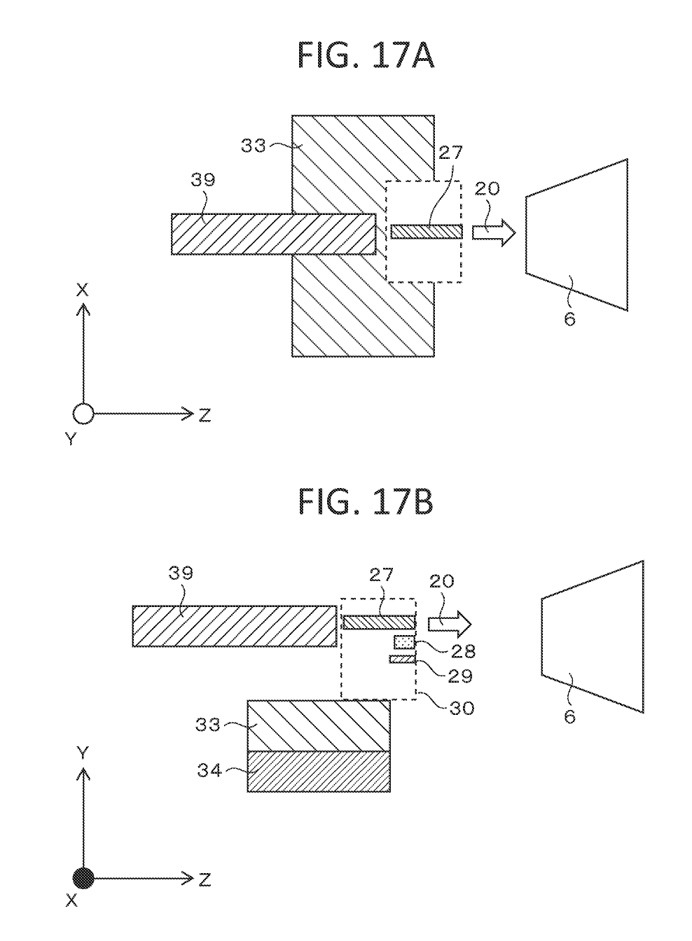

Next, a measurement method of light emitted from the optical waveguide element 24 will be described in detail using FIG. 3. FIG. 3 is an outline side view of main parts in the case where the optical waveguide element is a thermal assist magnetic write head including a thermal assist optical waveguide. The embodiment will be described using a case of using a thermal assist magnetic write head, as an optical waveguide element, having at least one core 27, a magnetic head 28, a magnetic read head 29, a laser diode 31, and a suspension 32. However, the present invention is not limited to the thermal assist magnetic write head. Light emitted from the laser diode 31 is guided into the core 27, and then is emitted in the direction of the arrow 20 from an ABS (Air Bearing Surface) 30. The reference numeral 6 denotes an objective lens of the element emission light imaging optical system 22, the reference numeral 33 denotes a θx stage, and the reference numeral 34 denotes a θy stage. Further, as an optical waveguide element, a thermal assist magnetic write head having at least one core 27, the magnetic head 28, and the magnetic read head 29 may be used to allow light to enter the core 27 using an external light source 39 as shown in FIGS. 17A and 17B. FIGS. 17A and 17B are outline views of main parts in the case where the optical waveguide element is another thermal assist magnetic write head including a thermal assist optical waveguide, in which FIG. 17A is a top view thereof and FIG. 17B is a side view thereof. It should be noted that the spot size of the light emitted from the core 27 of the thermal assist magnetic write head used in the embodiment is 1 μm or smaller. The thermal assist magnetic write head is fixed on the θx stage 33 and the θy stage 34. A distance (L2 of FIG. 3) between the objective lens 6 and the thermal assist magnetic write head is adjusted so that the focal position of the objective lens 6 corresponds to the position of the ABS 30. Namely, while an image output from the near-field pattern observing CCD image sensor 12 is observed with the light source for illumination 9 turned on, the whole element emission light imaging optical system 22 is moved in the Z direction and is fixed at the position where the image output from the near-field pattern observing CCD image sensor 12 is focused on the ABS 30. Further, the ABS 30 is set substantially in parallel with the objective lens 6 in such a manner that while the image output from the near-field pattern observing CCD image sensor 12 is observed with the light source for illumination 9 turned on, the whole element emission light imaging optical system 22 is moved in the X direction and the Y direction and the angles of the θx stage 33 and the θy stage 34 are adjusted so as to prevent the whole image output from the near-field pattern observing CCD image sensor 12 from being defocused. Following the above-described adjustment, the light source for illumination 9 is turned off.

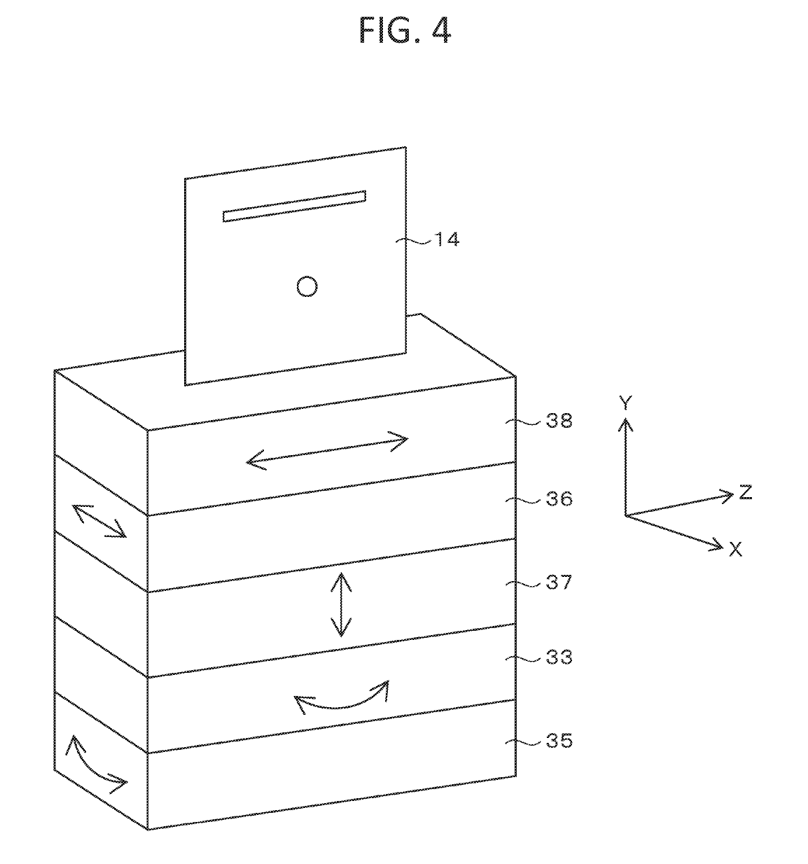

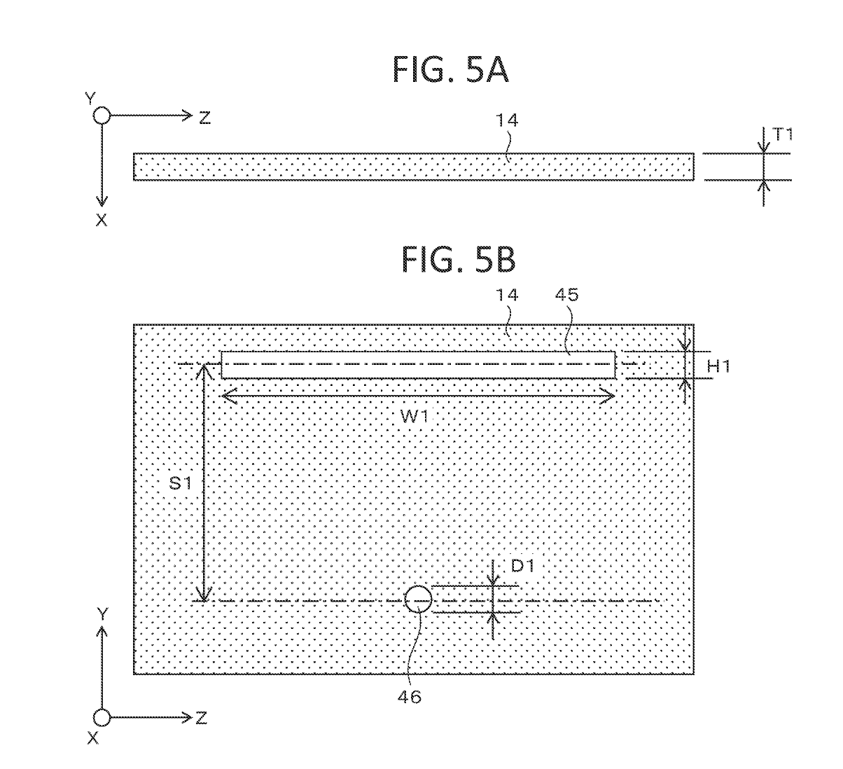

The pinhole plate 14 is inserted at the position of the near-field pattern 13 imaged in the air. A perspective view of the pinhole plate and a driving unit is shown in FIG. 4. The pinhole plate 14 is fixed on the driving unit including a θx stage 33, a θz stage 35, an X piezo stage 36, a Y piezo stage 37, and a Z piezo stage 38 as shown in FIG. 4. The θx stage 33 and the θz stage 35 are adjusted so that the pinhole plate 14 is set substantially in parallel with the near-field/far-field simultaneous measurement optical system 23. Further, the X piezo stage 36 is moved and adjusted so that the pinhole plate 14 is substantially overlapped with the position of the near-field pattern 13 imaged in the air in the X direction. FIGS. 5A and 5B are configuration diagrams for showing an example of the pinhole plate, in which FIG. 5A is a top view thereof and FIG. 5B is a side view thereof. As shown in FIGS. 5A and 5B, the pinhole plate 14 has a hole (pinhole 46) in substantially a true circle shape and a rectangular hole (slit 45). The thickness T1 of the pinhole plate 14 is 10 to 20 μm, and the pinhole plate 14 is made of Al that is a material that blocks light ranging from visible light to infrared light, or Al or Mo the surface of which is treated with alumite. The diameter D1 of the pinhole 46 of the pinhole plate 14 and the thickness H1 of the slit 45 are 10 μm, 20 μm, 30 μm, or 50 μm that is the current limitation of a process of making a hole. Here, a measurement method using the hole in a true circle shape of the pinhole plate 14 will be described. The pinhole 46 of the pinhole plate 14 is used to detect only light emitted from the neighborhood of the core 27 of the thermal assist magnetic write head using the near-field/far-field simultaneous measurement optical system 23. The Y piezo stage 37 and the Z piezo stage 38 are moved to adjust the position of the pinhole plate 14 so that the center of the pinhole 46 of the pinhole plate 14 corresponds to that of the light in the neighborhood of the core 27 emitted from the ABS 30 of the thermal assist magnetic write head on the near-field pattern 13 imaged in the air. It should be noted that while the near-field pattern image output from the second near-field pattern observing CCD image sensor 41 is observed, the position of the pinhole plate 14 is adjusted so that only the light in the neighborhood of the core 27 emitted from the ABS 30 of the thermal assist magnetic write head can penetrate.

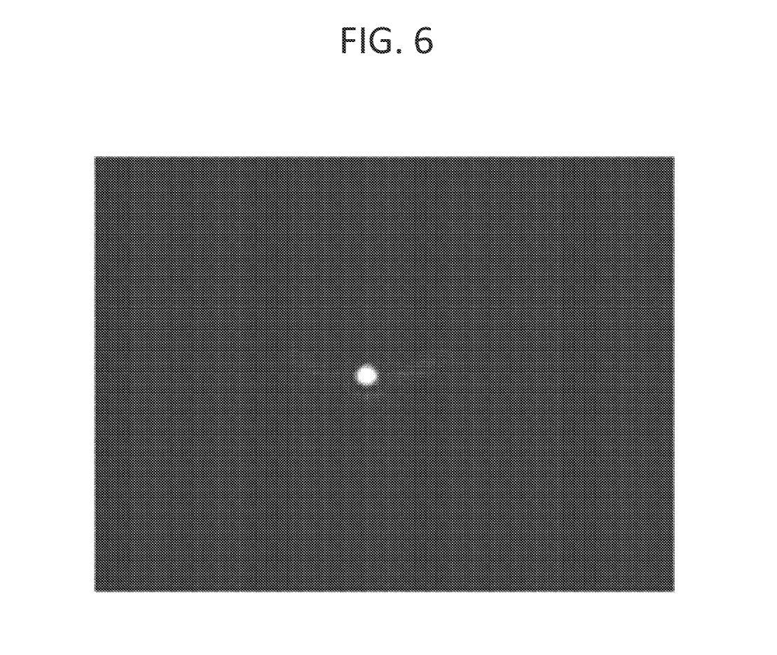

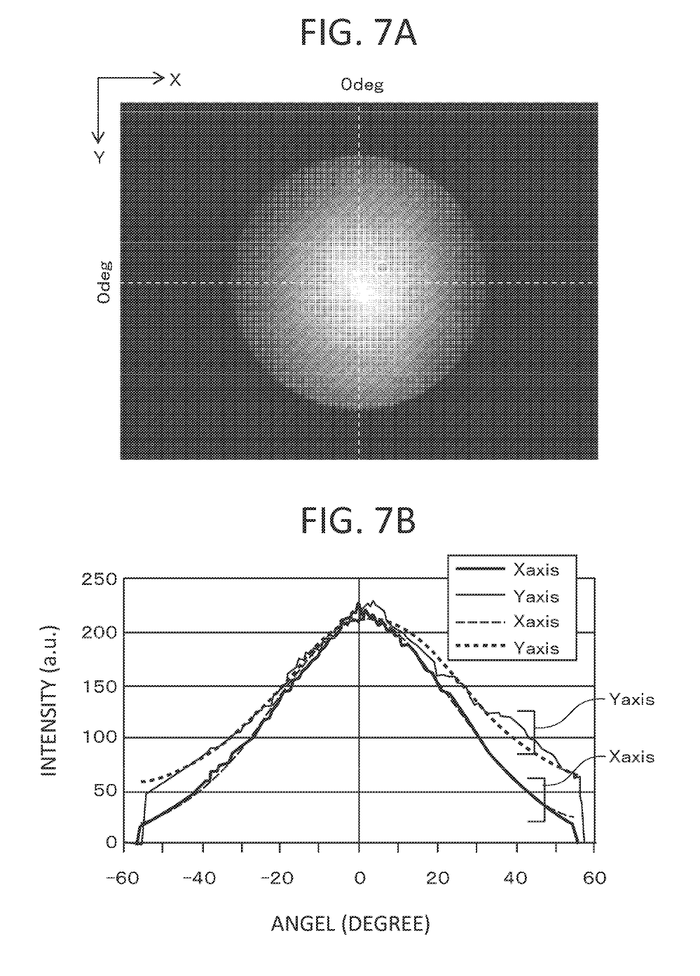

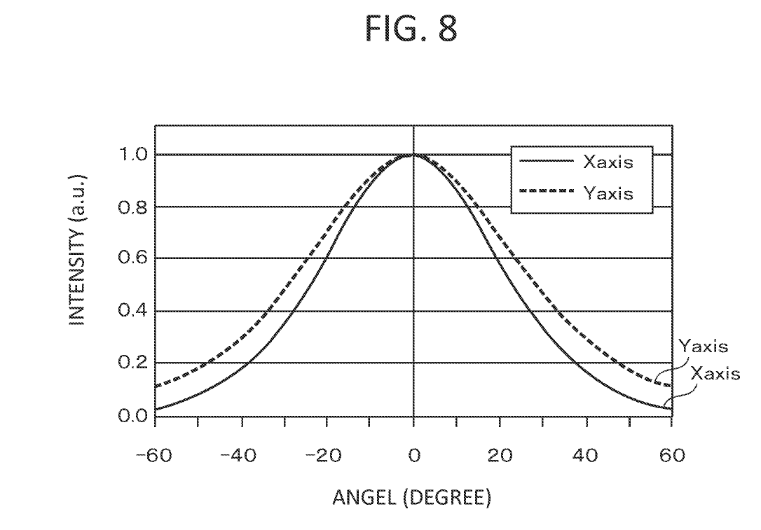

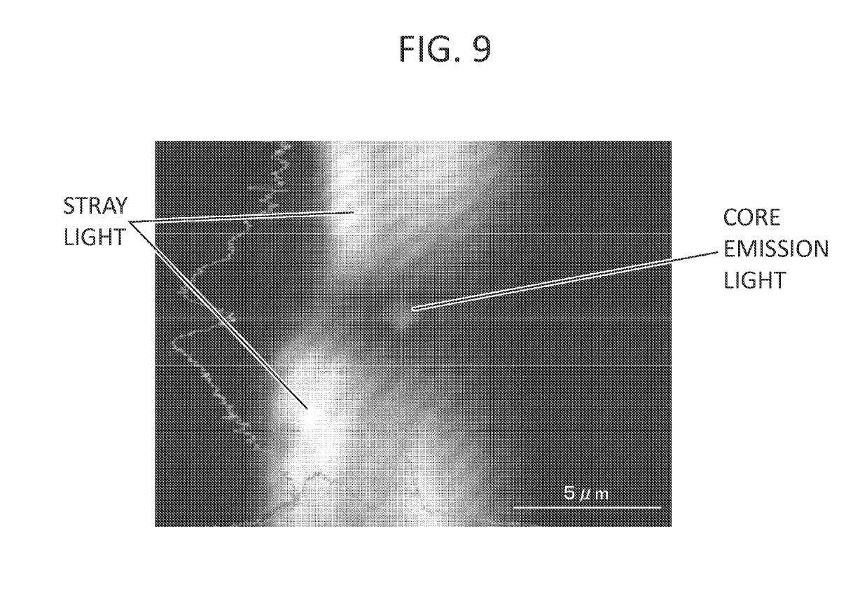

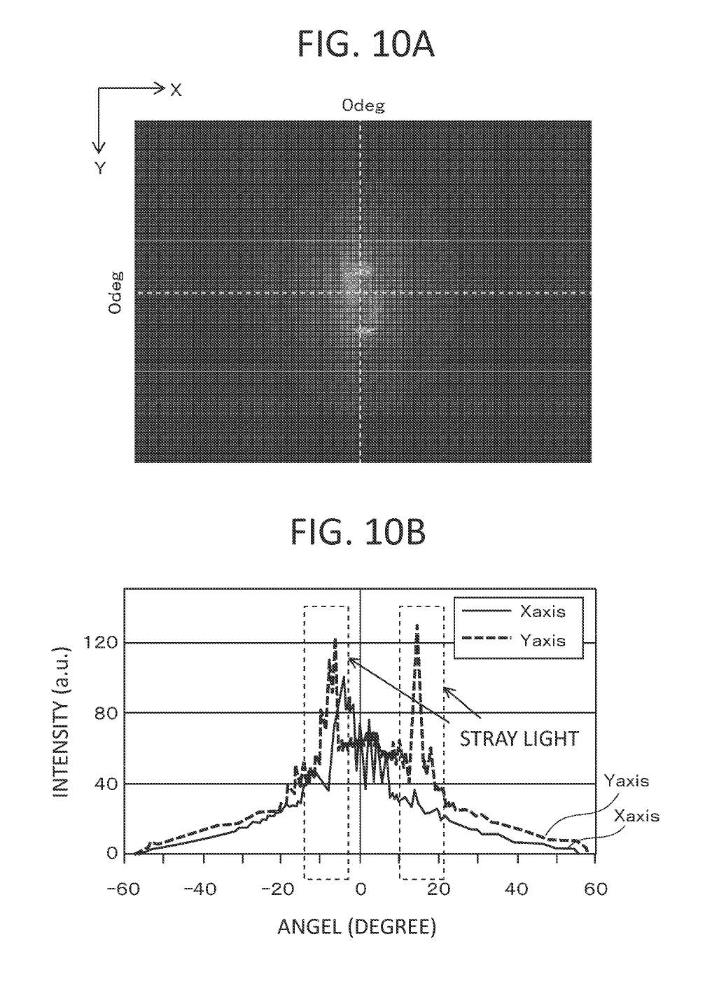

With this configuration, the light emitted from the position apart from the center of the core 27 of the thermal assist magnetic write head by about 0.5 μm, 1.0 μm, 1.5 μm, 2.5 μm, or larger can be effectively blocked. Following the adjustment of the position of the pinhole plate 14 as described above, the near-field pattern 13 imaged in the air is observed using the near-field/far-field simultaneous measurement optical system 23. The results are shown in FIG. 6 and FIGS. 7A and 7B. FIG. 6 shows a near-field pattern image obtained from the second near-field pattern observing CCD image sensor 41, and FIG. 7A shows an FFP image obtained from the FFP observing CCD image sensor 18. It should be noted that the result of a case in which the pinhole plate 14 was not used is shown for comparison in each of FIG. 9 and FIGS. 10A and 10B. FIG. 9 shows a near-field pattern image obtained from the second near-field pattern observing CCD image sensor 41, and FIG. 10A shows an FFP image obtained from the FFP observing CCD image sensor 18. Further, FIG. 8 shows a simulation result of the FFP of light emitted from the neighborhood of the core 27 of the thermal assist magnetic write head used in the embodiment. The near-field pattern image shows that the stray light is considerably blocked in the case of using the pinhole plate 14, as compared to the case in which no pinhole plate is used. Further, the FFP image shows a profile close to the simulation result of FIG. 8 in the case of using the pinhole plate 14. However, in the case of using no pinhole plate 14, strong stray light reaches a peak between angles of 10 to 15 degrees. Accordingly, if the method is used, the FFP image of only the light emitted from the neighborhood of the core 27 of the thermal assist magnetic write head can be obtained with a high degree of accuracy while blocking the stray light.

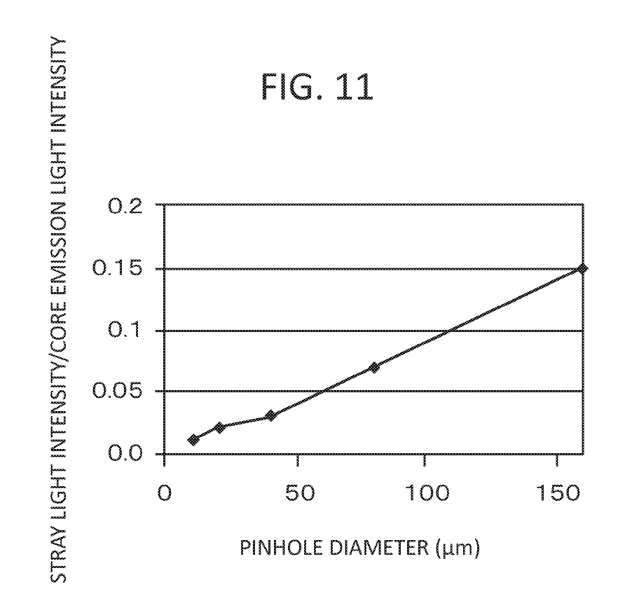

Further, the diameter D1 of the pinhole 46 of the pinhole plate 14 was studied. FIG. 11 shows a result obtained by measuring the dependency of the ratio of stray light intensity/core emission light intensity on the diameter D1 of the pinhole. Here, the stray light intensity means the total sum of stray light intensities, and the core emission light intensity means the total sum of intensities of light emitted from only the neighborhood of the core 27. The result of FIG. 11 shows that if the diameter D1 of the pinhole 46 of the pinhole plate 14 is 100 μm or smaller, the ratio of stray light intensity/core emission light intensity becomes 10% or smaller. It should be noted that 10% or smaller as the ratio of stray light intensity/core emission light intensity is a sufficient value in the case of observing the FFP. The diameter D1 of 100 μm effectively corresponds to 10 times the spot size of the light emitted from the neighborhood of the core 27 of the thermal assist magnetic write head. Thus, the diameter D1 of the pinhole 46 of the pinhole plate 14 is preferably 100 μm or smaller. In the above-described embodiment, the distance (L2 of FIG. 3) between the objective lens 6 and the thermal assist magnetic write head is set so that the focal position of the objective lens 6 corresponds to the position of the ABS 30. However, if the distance is made shorter, the near-field pattern image inside the thermal assist magnetic write head and the FFP image can be obtained while removing the stray light.

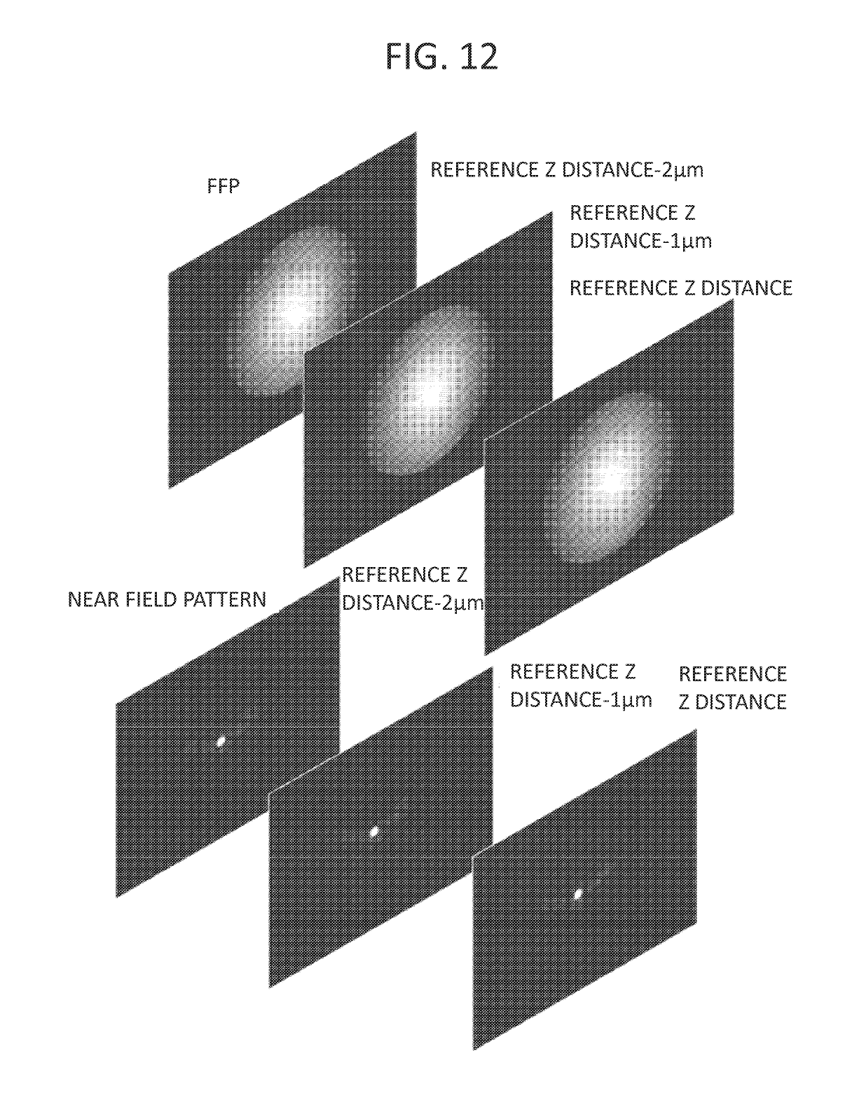

FIG. 12 shows near-field pattern images and FFP images obtained by the near-field/far-field simultaneous measurement optical system 23 in the case where the measurement was performed while the thermal assist magnetic write head was made closer to the objective lens 6 (namely, L2 of FIG. 3 is made shorter). On the basis of a case in which the focal position of the objective lens 6 corresponds to the position of the ABS 30, the distance between the objective lens 6 and the thermal assist magnetic write head is shortened by only 1 μm and 2 μm in the embodiment. The result shows that the stray light can be suppressed as similar to FIGS. 7A and 7B even in the case where the distance between the objective lens 6 and the thermal assist magnetic write head is made closer from the reference position by about 2 μm. It should be noted that observation of the state of stray light inside the thermal assist magnetic write head can be realized only by removing the pinhole plate 14.

Next, a measurement method using the rectangular hole (slit 45) of the pinhole plate 14 will be described. The slit 45 of the pinhole plate 14 is used to promptly identify a position on the plane of the ABS 30 where the stray light emitted at an arbitrary angle is highest in intensity. The thickness H1 (see FIG. 5B) of the slit 45 adopted is 100 μm or smaller as similar to the diameter D1 of the pinhole 46. The width W1 of the slit 45 adopted is longer than the width or height of the near-field pattern 13 imaged in the air. With this configuration, the light penetrating the slit 45 corresponds to all the light of the near-field pattern 13 in the width direction of the slit 45.

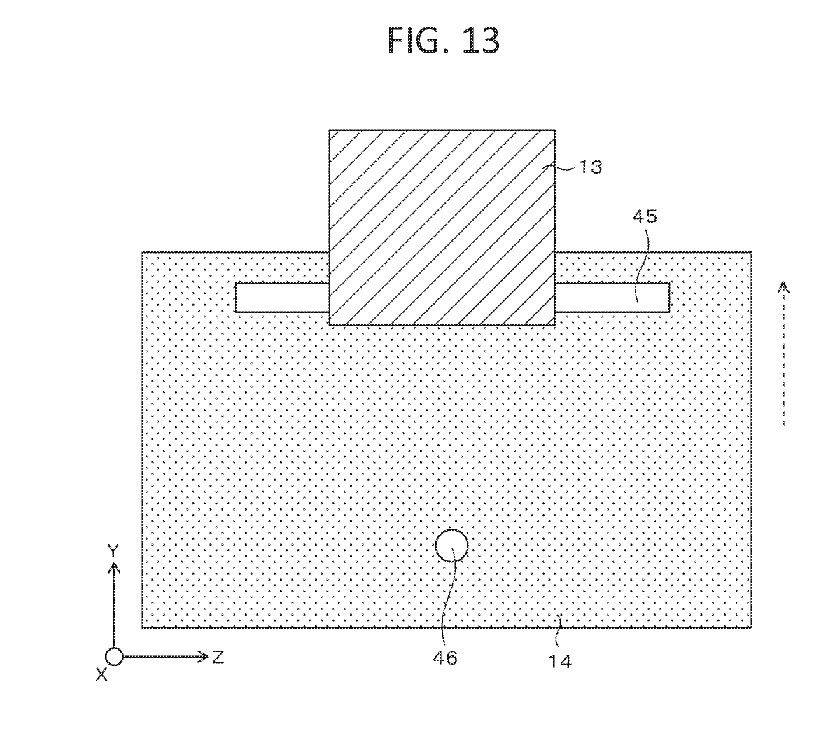

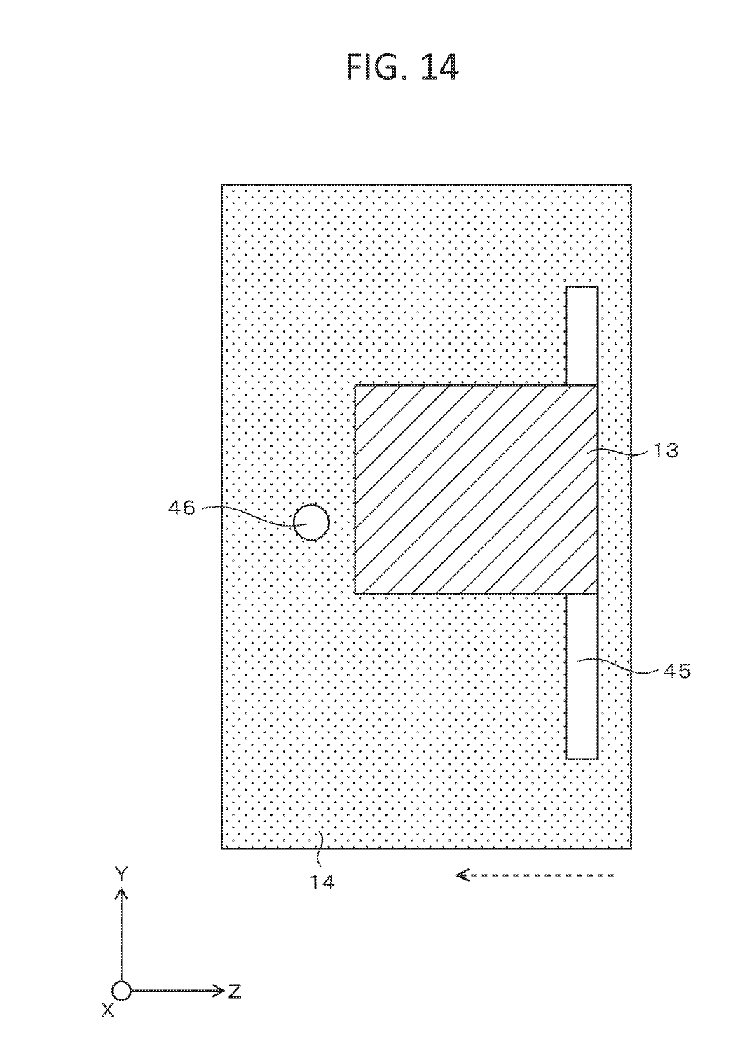

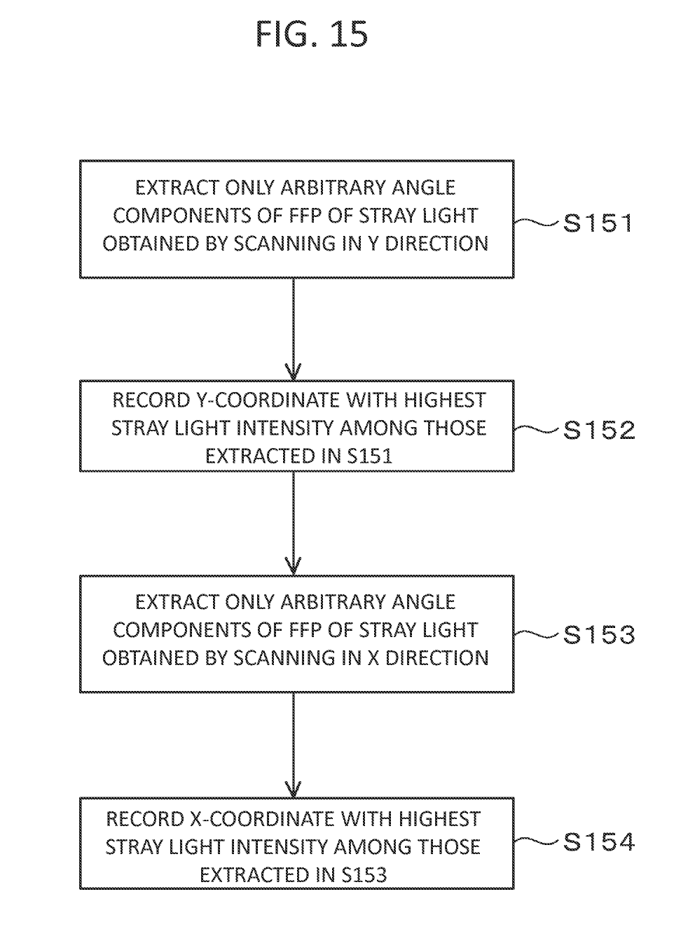

First, the slit 45 of the pinhole plate 14 is moved stepwise in the Y direction (in the direction of the dotted arrow) using the Y piezo stage 37 as shown in FIG. 13. This step corresponds to S151 of FIG. 15 (figure showing a processing flow used when the position with the highest stray light intensity in the FFP image is obtained for each emission angle), and includes a process in which only arbitrary angle components of the FFP of stray light obtained by scanning in the Y direction are extracted. In this case, while the FFP image is recorded in each step by the near-field/far-field simultaneous measurement optical system 23, the coordinate of the pinhole plate 14 is simultaneously recorded. This step corresponds to S152 of FIG. 15, and includes a process in which the Y-coordinate with the highest stray light intensity among those extracted in S151 is recorded. Next, as shown in FIG. 14, the pinhole plate 14 is rotated by 90 degrees using the θz stage, and the slit 45 of the pinhole plate 14 is moved stepwise in the X direction using the X piezo stage 36. This step corresponds to S153 of FIG. 15, and includes a process in which only arbitrary angle components of the FFP of stray light obtained by scanning in the X direction are extracted. In this case, while the FFP image is recorded in each step by the near-field/far-field simultaneous measurement optical system 23, the coordinate of the pinhole plate 14 is simultaneously recorded. This step corresponds to S154 of FIG. 15, and includes a process in which the X-coordinate with the highest stray light intensity among those extracted in S153 is recorded. It should be noted that when the slit 45 is moved stepwise and crosses the core 27, it is preferable to deduct the FFP image data measured using the pinhole 46 of the pinhole plate 14 and obtained using only the light in the neighborhood of the core 27 emitted from the ABS 30 of the thermal assist magnetic write head from the FFP image data. With this configuration, the all pieces of FFP image data measured using the slit 45 of the pinhole plate 14 are composed only stray light components.

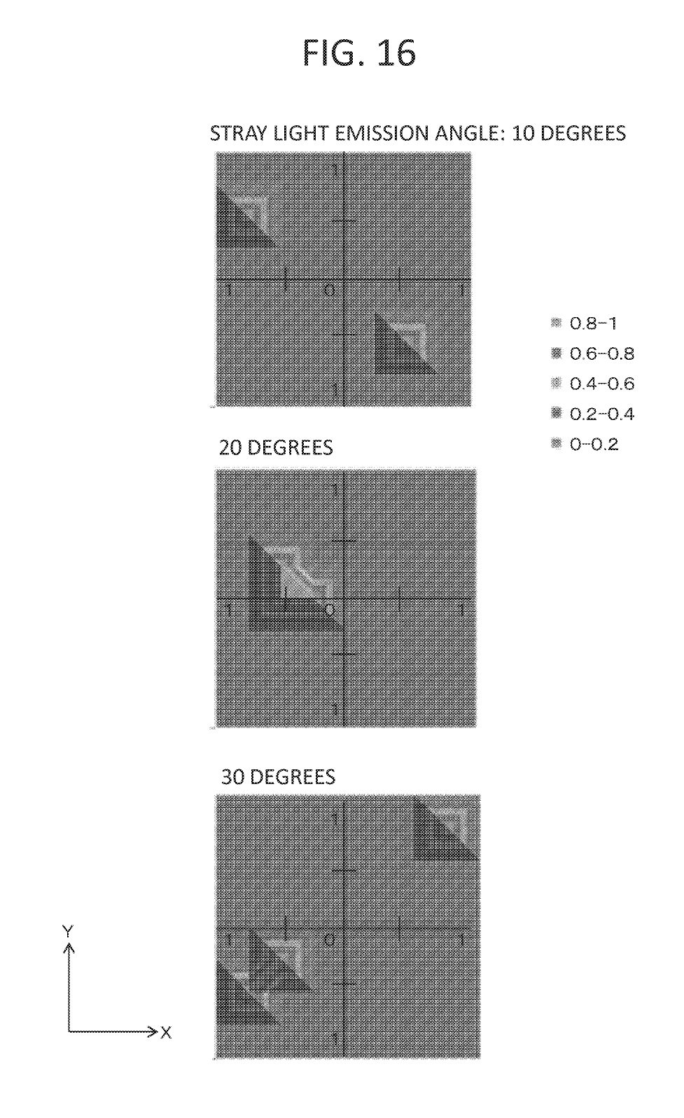

If the all pieces of FFP image data thus obtained are processed using the steps (S151 to S154) shown in FIG. 15, areas with the highest stray light intensity can be mapped for each emission angle of the stray light as shown in FIG. 16. It should be noted that using the area of the core 27 of the thermal assist magnetic write head as the original point, the horizontal direction represents the X axis and the vertical direction represents the Y axis in FIG. 16. It should be noted that each axis is standardized while assuming that the maximum travel distance of the slit 45 of the pinhole plate 14 from the core 27 as the center is 1. FIG. 16 shows results of mapping in the case of emission angles of 10 degrees, 20 degrees, and 30 degrees. Further, if the distance (L2 of FIG. 3) between the objective lens 6 and the thermal assist magnetic write head is changed, internal information of the thermal assist magnetic write head can be obtained as shown in FIG. 12. It should be noted that as a result of analyzing the areas with the highest stray light intensity obtained in FIG. 16 using an electron microscope, impurities different from materials existing around the core 27 were detected in the areas. Thus, the mapping data related to the stray light can be used for analysis of defects of the thermal assist magnetic write head.

It should be noted that the thermal assist magnetic write head is used for the optical waveguide element 24 that is a measurement target in the embodiment, but the embodiment is not limited to the thermal assist magnetic write head. The evaluation apparatus can be realized while a PLC (Planar Lightwave Circuit) that produces a silicon photonic device, or optical waveguides and various optical devices on an oxide film deposited on a silicon substrate is used as a measurement target.

According to the embodiment as described above, it is possible to provide an optical waveguide element evaluation apparatus and an optical waveguide element evaluation method in which stray light is separated and the distribution of light angles of an optical waveguide element can be evaluated.

### Second Embodiment

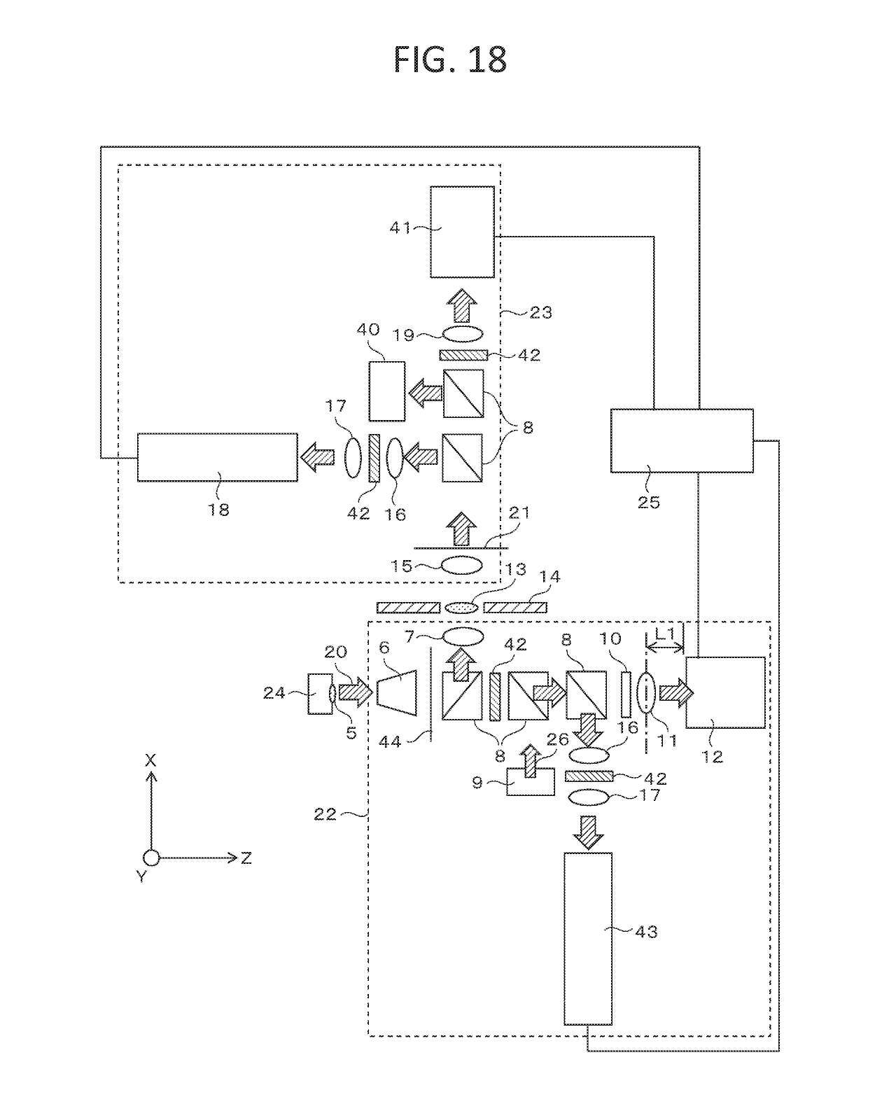

A second embodiment of the present invention will be described using FIG. 18. It should be noted that the matters that are described in the first embodiment but are not in the second embodiment can be applied to the second embodiment unless the circumstances are exceptional.

FIG. 18 is an outline overall plan view of an optical waveguide element evaluation apparatus according to the embodiment. The basic configuration of the optical waveguide element evaluation apparatus of the second embodiment is the same as that of the first embodiment. However, as a different point, the far-field measurement mechanism is provided only in the near-field/far-field simultaneous measurement optical system 23 in the first embodiment, but is provided similarly in the element emission light imaging optical system 22 in the second embodiment as shown in FIG. 18. In this case, the embodiment will be described using the Z direction of FIG. 18 as a reference. In FIG. 18, the half beam splitters 8 are further installed before the neutral density filter 10 of the element emission light imaging optical system 22. At one of the half beam splitters 8, provided are the convex lens (1)16, the convex lens (2)17, and the second FFP observing CCD image sensor 43 that are the same as those in the far-field measurement mechanism of the near-field/far-field simultaneous measurement optical system 23 of FIG. 1. With this configuration, an FFP image of emission light from the optical waveguide element 24 that is imaged on the rear side of the objective lens 6 can be detected. In the first embodiment, it is necessary to remove the pinhole plate 14 in order to detect an FFP image of emission light from the optical waveguide element 24 in a state where all stray light is contained. However, using the second embodiment, it is possible to detect an FFP image of emission light from the optical waveguide element 24 in a state where all stray light is contained without removing the pinhole plate 14. It should be noted that the reference numeral 44 denotes an FFP imaging position on the rear side of the objective lens.

Further, a power meter 40 is provided in the near-field/far-field simultaneous measurement optical system 23 as shown in FIG. 18, and the optical power of the optical waveguide element 24 in a state where stray light is removed can be directly measured in the embodiment. In this case, the embodiment will be described using the X direction of FIG. 18 as a reference. In FIG. 18, two half beam splitters 8 are installed on the rear side of the condensing convex lens 15, and the power meter 40 is provided at one of them. In this case, the Y piezo stage 37 and the Z piezo stage 38 are moved to adjust the position of the pinhole plate 14, so that the center of the pinhole 46 of the pinhole plate 14 corresponds to the center of the light in the neighborhood of the core 27 emitted from the ABS 30 of the thermal assist magnetic write head on the near-field pattern 13 imaged in the air. It should be noted that while the near-field pattern image output from the second near-field pattern observing CCD image sensor 41 is observed, the position of the pinhole plate 14 is adjusted so that only the light in the neighborhood of the core 27 emitted from the ABS 30 of the thermal assist magnetic write head can penetrate. With this configuration, only the emission light containing no stray light from the optical waveguide element 24 is guided to the power meter 40. As a result, the optical power of the emission light containing no stray light from the optical waveguide element 24 can be directly measured, and thus the efficiency of use of light of the optical waveguide element 24 can be estimated. It should be noted that when estimating the efficiency of use of light, it is possible to calculate the efficiency by preliminarily measuring the optical power entering the optical waveguide element 24. For example, in the case where the optical waveguide element 24 is the thermal assist magnetic write head shown in FIG. 3, the optical power of light emitted from only the laser diode 31 is measured. In the case where the optical waveguide element 24 is the thermal assist magnetic write head shown in FIGS. 17A and 17B, the optical power of light emitted from only the external light source 39 is measured.

Further, polarizing filters 42 are inserted before the respective CCD image sensors (the first near-field pattern observing CCD image sensor 12, the FFP observing CCD image sensor 18, the second near-field pattern observing CCD image sensor 41, and the second FFP observing CCD image sensor 43) as shown in FIG. 18 in the embodiment, so that the dependency of polarized light of the emission light from the optical waveguide element 24 can be measured. With this configuration, the characteristics of polarized light of the emission light containing no stray light from the optical waveguide element 24 and those of stray light can be recognized.

Even in the embodiment, it is possible to provide an optical waveguide element evaluation apparatus and an optical waveguide element evaluation method in which stray light is separated and the distribution of light angles of an optical waveguide element can be evaluated. Further, the far-field measurement mechanism is provided in the element emission light imaging optical system 22, so that it is possible to detect an FFP image of emission light from the optical waveguide element 24 in a state where all stray light is contained without removing the pinhole plate 14.

### Third Embodiment

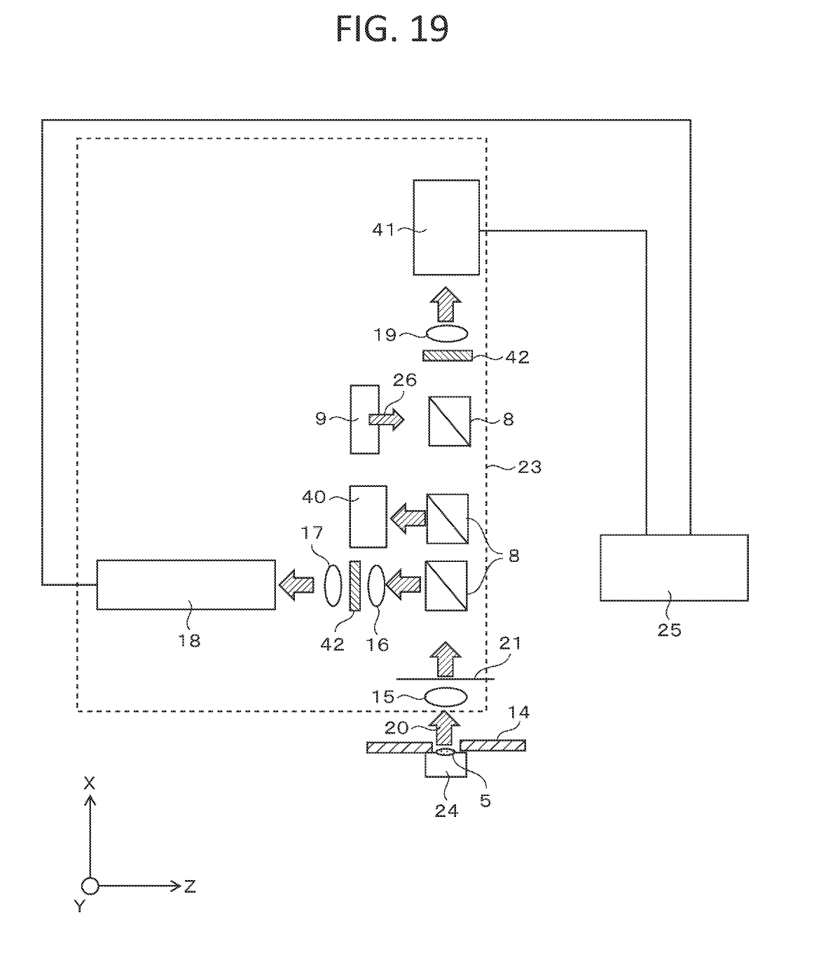

A third embodiment of the present invention will be described using FIG. 19. It should be noted that the matters that are described in the first and second embodiments but are not in the third embodiment can be applied to the third embodiment unless the circumstances are exceptional. FIG. 19 is an outline overall plan view of an optical waveguide element evaluation apparatus according to the embodiment. The basic configuration of the optical waveguide element evaluation apparatus of the third embodiment is the same as that of the first or second embodiment. However, as a different point, both of the element emission light imaging optical system 22 and the near-field/far-field simultaneous measurement optical system 23 are provided in the first and second embodiments, but only the near-field/far-field simultaneous measurement optical system 23 is used in the third embodiment as shown in FIG. 19. In this case, too, stray light is separated in the optical waveguide element and the distribution of light angles of the optical waveguide element can be evaluated. In this case, the optical waveguide element 24 is provided near the pinhole plate 14. In order to detect only the light (near-field pattern 5) emitted from the neighborhood of the core 27 using the near-field/far-field simultaneous measurement optical system 23, the diameter D1 of the pinhole 46 of the pinhole plate 14 is 10 times or smaller the spot size of the light emitted from the neighborhood of the core 27 as similar to the above-described embodiments. The thickness H1 of the slit 45 is 10 times or smaller the spot size of the light emitted from the neighborhood of the core 27 as similar to the diameter D1 of the pinhole 46. The width W1 of the slit 45 adopted is larger than the width or height of the optical waveguide element 24. It should be noted that the distance between the optical waveguide element 24 and the pinhole plate 14 is preferably as short as possible, and the end face of the emission light of the optical waveguide element 24 may be substantially brought into contact with the pinhole plate 14. In the embodiment, it is preferable to install the light source for illumination 9 in the near-field/far-field simultaneous measurement optical system 23. It should be noted that light emitted from the light source for illumination 9 is turned by the half beam splitter 8 and is propagated in the direction of the condensing convex lens 15.

Even in the third embodiment, a case in which the thermal assist magnetic write head is used for the optical waveguide element 24 will be described as similar to the above-described embodiments. The thermal assist magnetic write head is fixed on the θx stage 33 and the θy stage 34. A distance between the condensing convex lens 15 and the thermal assist magnetic write head is adjusted so that the focal position of the condensing convex lens 15 corresponds to the position of the ABS 30. Namely, while an image output from the near-field pattern observing CCD image sensor 12 is observed with the light source for illumination 9 turned on, the whole near-field/far-field simultaneous measurement optical system 23 is moved in the X direction and is fixed at the position where the image output from the second near-field pattern observing CCD image sensor 41 is focused on the ABS 30. Further, the ABS 30 is set substantially in parallel with the condensing convex lens 15 in such a manner that while the image output from the second near-field pattern observing CCD image sensor 41 is observed with the light source for illumination 9 turned on, the whole near-field/far-field simultaneous measurement optical system 23 is moved in the X direction and the Y direction and the angles of the θx stage 33 and the θy stage 34 are adjusted so as to prevent the whole image output from the second near-field pattern observing CCD image sensor 41 from being defocused. Following the above-described adjustment, the light source for illumination 9 is turned off.

The other configurations of the apparatus and the other measurement procedures are the same as those of the second embodiment.

Even in the embodiment, it is possible to provide an optical waveguide element evaluation apparatus and an optical waveguide element evaluation method in which stray light is separated and the distribution of light angles of an optical waveguide element can be evaluated. Further, the element emission light imaging optical system can be omitted, and thus the apparatus can be downsized.

The invention of the present application has been described above in detail, and the main aspects of the invention will be listed below.

The present invention establishes the evaluation apparatus including the optical system by which the near-field image at the end face of emission light from the optical waveguide element that is a measurement target is magnified and imaged in the air, the optical system by which the near-field pattern and the far-field pattern are simultaneously detected, and the pinhole plate having plural holes.

The near-field image at the end face of emission light from the optical waveguide element that is a measurement target is imaged in the air by increasing the magnification using the objective lens and the convex lens whose focal distance is longer than that of the objective lens. The pinhole plate is installed at the same position as the imaged image, and stray light contained in the emission light from the optical waveguide element is removed using one hole (pinhole) that is provided in the pinhole plate and is formed in effectively a true circle shape. The image in the air with the stray light removed is condensed by the convex lens, and is propagated on the rear side of the convex lens as parallel light. The propagated light is branched into two, one of which is propagated to the power meter and the other of which is imaged on the CCD image sensor through the lens. Since the stray light of the light having reached the power meter has been already removed, the power of only the light propagating in the neighborhood of the core of the optical waveguide element can be measured.

The far-field pattern of the image in the air condensed by the convex lens is imaged on the rear side of the convex lens. The imaged far-field pattern image is imaged on the CCD image sensor by the relay lens composed of two convex lenses. Accordingly, the far-field pattern of the image in the air with the stray light removed can be measured. The spot size of the light emitted from only the neighborhood of the core of the optical waveguide element can be analytically derived using the far-field pattern.

Further, the distribution of the stray light emitted at arbitrary angles at the end face of the emission light from the optical waveguide element is measured using one effective rectangular hole (slit) provided in the pinhole plate. While the slit is moved stepwise in one direction on the far-field pattern of the image in the air, the far-field pattern is taken in each step. It should be noted that the position of the slit on the image in the air is recorded when the far-field pattern is taken. Thereafter, the rectangular hole is rotated by 90 degrees, and the far-field pattern is taken in each step while moving the rectangular hole stepwise as similar to the above in the direction orthogonal to the one direction. Thereafter, only arbitrary angle components of each far-field pattern are analyzed, and the distribution of the stray light emitted at arbitrary angles at the end face of the emission light from the optical waveguide element can be calculated.

In addition, the focal position of the objective lens is provided inside the optical waveguide element in the present invention, and thus the far-field pattern and the near-field pattern in the waveguide element can be obtained. Accordingly, the distribution of the stray light emitted at arbitrary angles can be three-dimensionally mapped.

It should be noted that the present invention is not limited to the above-described embodiments, but includes various modifications. For example, the embodiments have been described in detail to understandably explain the present invention, and are not necessarily limited to those having the all constitutional elements described above. Further, a part of the configuration in one embodiment can be replaced by a configuration of another embodiment, and the configuration in one embodiment can be added to another embodiment. In addition, a part of the configuration in the embodiments can be added to or replaced by another, or deleted. For example, the thermal assist magnetic write head is used for the optical waveguide element 24 that is a measurement target in each embodiment, but each embodiment is not limited to the thermal assist magnetic write head. The evaluation apparatus can be realized while a PLC (Planar Lightwave Circuit) that produces a silicon photonic device, or optical waveguides and various optical devices on an oxide film deposited on a silicon substrate is used as a measurement target.

What is claimed is:

1. An optical waveguide element evaluation apparatus that evaluates emission light from an optical waveguide element, the apparatus comprising:
optical path setting devices that image a near-field pattern at an end face of the emission light from the optical waveguide element in the air;
a pinhole plate that includes opening portions which the imaged near-field pattern penetrates; and
a detection unit that detects the spread angle of the light at the end face of the emission light using a far-field pattern formed of the light penetrating the pinhole plate.

2. The optical waveguide element evaluation apparatus according to claim 1, wherein each optical path setting device that images the near-field pattern at the end face of the emission light from the optical waveguide element in the air includes an objective lens and a lens having a focal distance longer than that of the objective lens.

3. The optical waveguide element evaluation apparatus according to claim 1, wherein the pinhole plate has holes formed in effectively true circle and rectangular shapes.

4. The optical waveguide element evaluation apparatus according to claim 1, wherein the detection unit that detects the spread angle of the light has a group of lenses that condense an image imaged in the air to image the far-field pattern, and the optical path setting devices are provided to image the far-field pattern imaged by the group of lenses on the detection unit again.

5. The optical waveguide element evaluation apparatus according to claim 1, wherein the pinhole plate is located at effectively the same position as the image imaged in the air and blocks a part of light of the image imaged in the air.

6. The optical waveguide element evaluation apparatus according to claim 1, wherein the optical path setting devices are provided to allow the light penetrating the pinhole plate to reach the detection unit that detects the spread angle of the light and a light amount detector.

7. The optical waveguide element evaluation apparatus according to claim 2, wherein a driving device that changes a distance between the end face of the emission light from the optical waveguide element and the objective lens and another driving device that moves the pinhole plate are further provided.

8. The optical waveguide element evaluation apparatus according to claim 1, wherein a first near-field pattern detection unit that detects the near-field pattern at the end face of the emission light and a second near-field pattern detection unit that detects the near-field pattern imaged in the air are further provided.

9. The optical waveguide element evaluation apparatus according to claim 8, wherein a second detection unit that detects the spread angle of the light at the end face of the emission light using the near-field pattern at the end face of the emission light from the optical waveguide element is further provided.

10. An optical waveguide element evaluation apparatus that evaluates emission light from an optical waveguide element, the apparatus comprising:
an optical system that images a far-field pattern at an end face of emission light using light that is emitted from the end face of the emission light from the optical waveguide element and penetrates a pinhole plate; and
a detection unit that detects the spread angle of the light at the end face of the emission light using the far-field pattern.

11. The optical waveguide element evaluation apparatus according to claim 10, wherein a detection unit that detects a near-field pattern at the end face of the emission light using the light that is emitted from the end face of the emission light from the optical waveguide element and penetrates the pinhole plate is further provided.

12. The optical waveguide element evaluation apparatus according to claim 10, wherein a power meter that measures the optical power of the optical waveguide element using the light that is emitted from the end face of the emission light from the optical waveguide element and penetrates the pinhole plate is further provided.

13. The optical waveguide element evaluation apparatus according to claim 10, wherein a light source for illumination that illuminates the end face of the emission light from the optical waveguide element is further provided.

14. An optical waveguide element evaluation method comprising:
a first step of emitting light from an end face of emission light from an optical waveguide element;
a second step of adjusting a position so that a near-field pattern at the end face of the emission light is overlapped with a pinhole plate;
a third step of imaging a far-field pattern at the end face of the emission light using the near-field pattern arranged at the position overlapped with the pinhole plate; and
a fourth step of detecting the spread angle of the light at the end face of the emission light by imaging the far-field pattern again through an optical system.

15. The optical waveguide element evaluation method according to claim 14, wherein the near-field pattern whose position is adjusted to be overlapped with the pinhole plate in the second step is a near-field pattern imaged in the air.
